(19) United States
(12) Patent Application Publication
(10) Pub. No.: US 2014/0252173 A1
(43) Pub. Date: Sep. 11, 2014

(54) AQUACULTURE NET WITH WALLS WITH DIFFERENT WIRE DIRECTION

(71) Applicant: NV BEKAERT SA, 8550 Zwevegem (BE)

(72) Inventors: Alejandro Suazo Luengo, Talcahuano (CL); Hector Marmaduque Paredes Montecinos, Talcahuano (CL)

(21) Appl. No.: 14/351,394

(22) PCT Filed: Sep. 27, 2012
(86) PCT No.: PCT/EP2012/069100

§ 371 Date: Apr. 11, 2014

(30) Foreign Application Priority Data
Oct. 13, 2011 (EP) 11185007.9

(51) Int. Cl. A01K 61/00

(52) U.S. Cl. CPC A01K 61/007
USPC 245/10

(57) ABSTRACT

An aquaculture net (20) has one or more side walls. These side walls comprise wires (12, 14) in a wavy form with maxima and minima, wherein the maxima of one wire (12) interlock with minima of a neighboring wire (14) to form patterns of a series of diamonds. The one or more of side walls have at least two parts (22, 24) wherein the wire direction in one (22) of said parts is different from the wire direction in another (24) of said parts. The aquaculture net (20) thus combines the advantages of a net with horizontal wires in the side walls with the advantages of a net with vertical wires in the side walls.

### TECHNICAL FIELD

The invention relates to an aquaculture net with an improved wall design and a prolonged lifetime.

### BACKGROUND ART

Aquaculture nets or fish-farming nets are used to raise aquatic life such as fish. The aquaculture net keeps the aquatic life controlled and contained and protects the aquatic life inside the net against predators such as sharks, piranhas, nutrias, seals and sea lions.

The dimensions of such an aquaculture net are considerable. An example of a typical dimension is 30 m×30 m×15 m, the last dimension being the depth of the net inside the water and the first two dimensions being the width and length of the net at the water surface. The net may be formed of a polymer wire or of a coated steel wire. As a matter of example only, a net made of copper nickel plated stainless steel wire and of the above-mentioned dimensions has a weight above 4 metric Tonnes.

The aquaculture nets are usually of the chain-link fence type. This is a fence of steel wires woven into a diamond pattern. The meshes have a dimension that is smaller than the dimension of the fish contained in the nets. Each steel wire is pre-formed by bending so that it exhibits a wavy form with maxima and minima. The maxima or the peak of the wave has the highest amplitude value while the minima or the trough of the wave has lowest amplitude value. The maxima of a steel wire interlock with the minima of a neighbouring wire to form patterns of a series of diamonds.

Aquaculture nets of the chain-link fence type have proven to be successful to control the aquatic life and to protect against predators. Aquaculture nets with metal plated steel wires, such as galvanized steel wires or copper alloy coated stainless steel wires offer an acceptable resistance against bio-fouling, i.e. against fouling material that may grow on the mesh structure. The terms fouling material refer to fouling organisms such as barnacles, algae or molluscs, which may attach and grow to the wire material of the mesh structure. This fouling mechanism is so persistent that entire openings in the meshes may be filled blocking any introduction of fresh water or nutrition into the volume inside the mesh structure.

Experience has shown, however, that having regard to the corrosive environment of the ocean or the sea and to the movement of the tidings, aquaculture nets of the chain-link fence type also have some disadvantages.

On the one hand, some types of aquaculture nets of the chain-link fence type show broken wires after lapse of time. These broken wires eventually result in openings in the nets becoming greater.

On the other hand, other types of aquaculture nets of the chain-link fence type are subject to volume reductions of the net.

### DISCLOSURE OF INVENTION

It is an object of the invention to avoid the disadvantages of the prior art.

It is also an object of the invention to provide an aquaculture net with a prolonged life time.

It is a further object of the invention to provide a high volume aquaculture net which is not or less subject to volume reductions.

It is still another object of the invention to reduce wire fractures in an aquaculture net.

After careful study, the inventors have found that chain link mesh fence has a stiff and a flexible direction. The stiff direction is the average direction when following one wire in the chain link. Having regard to the material of the wire, usually metal, and to the diameter of the wire, this “wire” direction has low deformation since the wire keeps its rigidity. The wire has a zigzag-like pattern, with maxima and minima. Where two adjacent wires of a chain link fence are “hooked” in each other with the maxima of one wire in the minima of the adjacent wire, a flexible movement may exist. This is the flexible direction and is about perpendicular to the wire or stiff direction.

This analysis and observation has led to an explanation why some types of an aquaculture net show more broken wires than others. This analysis and observation has also led to an explanation why other types of an aquaculture net are more subject to volume changes than others.

Aquaculture nets with a horizontal stiff direction or horizontal wire direction in the walls, are more subject to wire fractures, particularly in the upper part of the net.

The term “horizontal” hereby refers a direction which is about parallel to the average direction of the surface of the water or the raft.

The reason for the above fractures is that the upper horizontal wires have to carry the weight of the rest of the net. As mentioned above, this weight can be considerable. In addition, the net is put in use in a very aggressive environment, where corrosion is a permanent threat combined with sometimes heavy movements because of the tidings. In a vertical direction, the walls of the net are much more flexible and follow to some extent the movements of the water. As a result of this flexible movement, neighbouring wires sometimes contact and sometimes loose contact, resulting in abrasive wear and fretting at the maxima and minima. This abrasion results in loss of the protective coating, zinc or a copper alloy. This loss is more or less the same over the whole length of the horizontal wires. As a result, the horizontal wire loses its corrosion protection over the entire length in relatively limited period of time. The fretting and the loss of cathodic protection combined with the heavy loads of the rest of the net, are the reasons for the frequent fractures at the upper side of aquaculture nets with horizontal wire direction.

On the other hand, aquaculture nets with horizontal wire direction in the walls are less subjected to volume reductions thanks to the stiffness inherent to the horizontal wire direction. So metallic nets with horizontal wires in the net walls maintain the entire net shape quasi intact, avoiding volume changes and wall movement during breeding cycles, and thus minimizing damage to the fishes. In addition, the net weight maintains the mesh openings at their maximum size facilitating water flux through the net and oxygen content inside.

Another advantage of nets with horizontal configuration is that one can use a wire diameter that is smaller when it is used closer to the bottom. So using thicker wires at top level, e.g. 5.10 mm, and decreasing in the middle wall and using thinner wires at bottom level e.g. 2.0 mm. This optimization in material was disclosed in US-A1-2011/0048331.

According to Japanese and Australian practice, there are also aquaculture nets with a vertical wire orientation. The rigid direction is vertically disposed so there is less compression or movement in vertical direction.

This configuration is advantageous because it distributes the net weight homogeneously in each wire, i.e. each wire stands the same load as the other wire next to it, ensuring a useful lifetime. In addition, in case of fretting corrosion, the protective coating starts to disappear at the upper part of these vertical wires, still leaving protective coating at the lower part and thus still providing cathodic protection.

However, due to the vertical wire disposition, the volume of the net can be changed by a likely horizontal displacement of wires in the flexible direction, thereby decreasing net volume and therefore jeopardizing fish condition. Additionally, a maximum mesh opening can not be reached because of the movement of the wire in horizontal direction.

Another disadvantage of the vertical configuration is that material optimization by using varying wire diameters—thicker wires at the top, thinner wires at the bottom—is either impossible or more difficult to achieve, in comparison with the horizontal configuration. For achieving this in vertical configuration, each wire must be cut and then joined using spirals, bar rod u other and then changing the wire diameter.

The present invention now combines the advantageous aspects of each of the above (horizontal and vertical) wire configurations.

According to a first aspect of the invention there is provided an aquaculture net having one or more side walls. These side walls comprise wires in a wavy form with maxima and minima, wherein the maxima of one wire interlock with minima of a neighboring wire to form patterns of a series of diamonds. At least one of these side walls comprises at least two parts wherein the wire direction in one of said parts is different from the wire direction in another of said parts.

Preferably the wire direction in one of the parts forms a first angle with the wire direction in another of the parts, and this first angle is larger than 45°, e.g. larger than 60°, e.g. larger than 75°.

In an embodiment the two parts of the aquaculture net form an upper part and a lower part in the side wall.

Preferably the wire direction in the upper part forms a second angle with a vertical, where this second angle is smaller than 15°, e.g. smaller than 10°, e.g. about 0°.

Preferably the wire direction in the lower part forms a third angle with a horizontal, where this third angle is smaller than 15°, e.g. smaller than 10°, e.g. about 0°.

The lower part is defined as that part of the side wall deepest in the water or closest to the bottom net, the top or upper part is that part of the side wall closest to the water level or closest to the raft.

The advantages of the aquaculture net of the present invention are a homogeneous load distribution combined with a steady volume during fish farming operations. The upper part of the net wall has a vertical wire orientation which distributes the net weight homogeneously at least in the splash zone, i.e. in the upper zone, while the horizontal wire orientation of the lower part of the net wall keeps the net shape stable, thus avoiding volume reductions and fish damage.

Additionally, as has been explained above, the vertical configuration in the splash zone is advantageous for corrosion protection.

Providing both vertical and horizontal configurations in one or more aquaculture net walls results in an overall improved resistance against corrosion and deformation and a prolonged lifetime of the whole aquaculture net.

The two or more parts in the walls are joined to each other. This can be done by means of a spiral wire or strand, a wire rod, an interwoven rope or wire, a tube, a connection clip or a combination of any of these.

The parts in the walls all have wires with a limited length, and thus with a beginning end and a trailing end. In order to avoid creating weaknesses in the parts, these ends are knotted. The knots can be simple knots, double knots or spring knots.

Most preferably the spiral wire or strand, the wire rod, the tube and/or the connection clips connect the knotted ends of one part to a neighbouring wire of another part.

The aquaculture net according to the invention is preferably a chain link fence, made of metal wires, e.g. metal coated steel wires. The metal coating can be zinc or a zinc alloy, or a copper alloy. Examples of a copper alloy are copper nickel or copper nickel tin. Metal steel wires with an organic coating are also possible. The organic coating may provide protection against corrosion, fretting and even bio-fouling, e.g. being doped medicines with bacteria killing properties. The organic coating may be selected from a polymer of the group consisting of high-density polyethylene, polyester or polyvinylchloride. Other suitable organic coatings are those resistant to corrosion and/or abrasion. Within the context of the present invention, the terms “polyester” denote not only polyethylene terephtalate or homopolymers of ethylene terephthalate but also copolymers of ethylene terephthalate containing not more than 20% of other copolymerized units, e.g. derived from other acids than terephthalic acid, such as isophtalic acid or from other glycols than ethylene glycol. The polymer may also contain mixtures of polymers in order to modify certain of the properties thereof.

In case of steel wires, the wires may have a diameter ranging from 0.50 mm to 5.10 mm, e.g. from 1.0 mm to 4.0 mm, e.g. from 2.0 mm to 3.5 mm. The steel wires have a tensile strength greater than 400 MPa, e.g. more than 1800 MPa, e.g. greater than 1500 MPa.

The aquaculture net may further be additionally treated against bio-fouling and corrosion, and may have dimensions which are greater than 1 m×1 m×1 m (length×width×depth), e.g. greater than 5 m×5 m×5 m, e.g. greater than 10 m×10 m×10 m.

The invention may be used for any net design, e.g. round, square, rectangular, tapered, octagonal . . .

The vertical/horizontal configuration and/or ratio may be according to net design considering shape and size.

The known benefits of the aquaculture net of the invention are set out here for a vertical wire direction in the top of the wall and a horizontal wire direction in the area below. Nevertheless, an inverted and/or repeated configuration in walls (inverted: horizontal wires in the top of the wall and vertical wires in the area below—repeated: vertical wires, horizontal wires, vertical wires, horizontal wires . . . ) can also be achieved.

### BRIEF DESCRIPTION OF DRAWINGS

FIG. 1a shows a chain link mesh and FIG. 1b shows a simplified representation of a chain link mesh.

FIG. 2 shows a schematic drawing of an aquaculture net according to the present invention;

FIG. 3 shows a connection between two parts in a wall of an aquaculture net;

FIG. 4a illustrates a simple knot;

FIG. 4b illustrates a double knot; and

FIG. 4c illustrates a spring knot.

FIG. 5a spool or spiral rope for joining mesh parts; and

FIG. 5b illustrates a clip for joining mesh parts.

### DESCRIPTION OF PREFERRED EMBODIMENTS

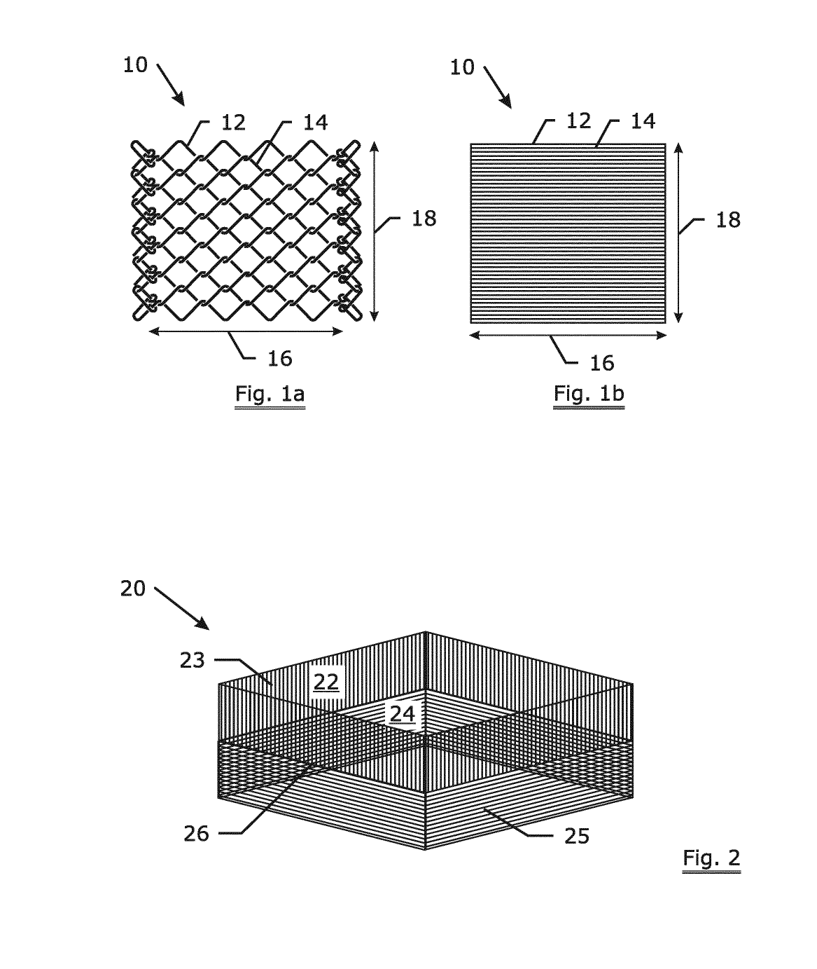

FIG. 1a and FIG. 1b illustrate the analysis which is at the origin of the problems met with vertical or horizontal nets.

FIG. 1a shows a chain link mesh 10. This chain link mesh is composed of several wires 12, 14 having a zigzag-like pattern and which are braided or linked into each other. Having regard to the material of the wires, usually steel, and to the diameter of the wires, about 0.5 to 5.10 mm, the average direction 16 of the wires 12, 14 is the stiff direction while the direction 18 perpendicular hereto is the flexible direction.

FIG. 1b is now a schematic and simplified illustration of chain link mesh 10. The lines 12, 14 in FIG. 1b indicate the corresponding stiff wire direction 16 of the mesh of FIG. 1a while the flexible direction 18 is perpendicular thereto.

FIG. 2 shows an embodiment of a rectangular aquaculture net 20 according to the invention comprising four so-called hybrid walls, i.e. walls with different wire orientations. The four walls each have an upper part 22 with vertical wires 23 and a lower part 24 with horizontal wires 25. The lower part 24 is connected to the upper part 22 by means of a spiral or bar interface 26. Although in this embodiment the upper and lower net parts are both half of the net depth, other ratios are possible and/or combinations are possible.

### EXAMPLES

upper part with vertical wires and 25% of the depth, lower part with horizontal wires and 75% of the depth;

four parts, each 25% of the depth, vertical configuration alternating with horizontal configuration.

Other aquaculture nets according to the invention may also comprise any advantageous combinations of horizontal and vertical wire configurations in one or more net walls, or an angled version thereof, whereby the horizontal and/or vertical wire direction is in an angle of 10°, 20° or 30° of the horizontal and/or vertical direction.

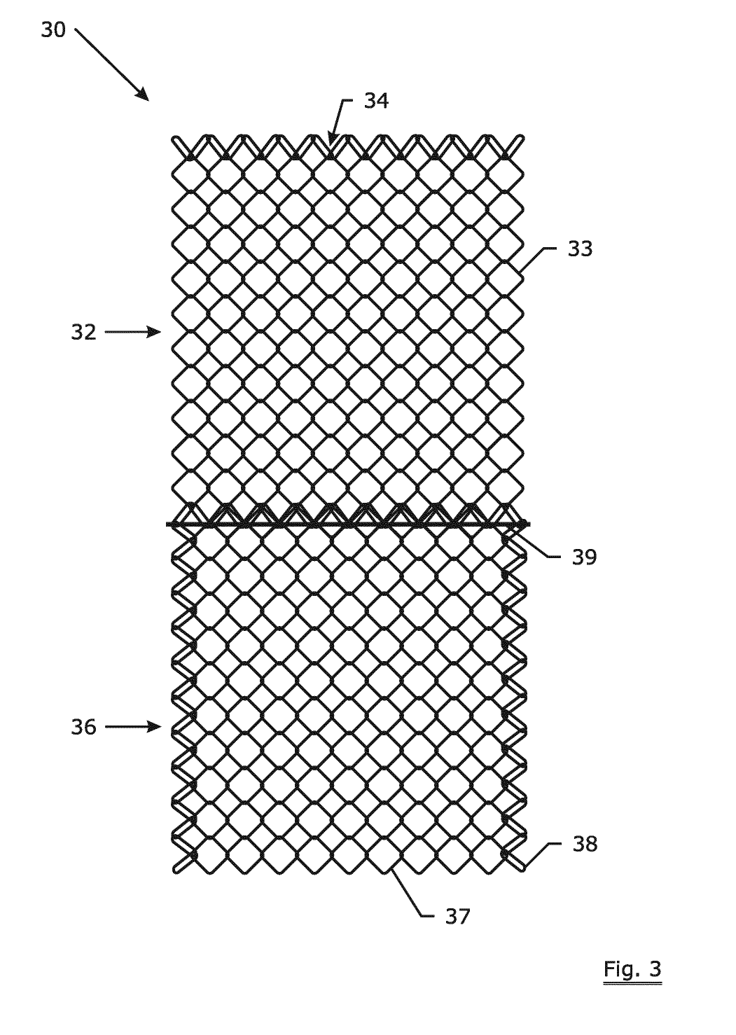

FIG. 3 illustrates in more detail a so-called hybrid wall 30 of an aquaculture net according to the present invention.

The upper part 32 has vertically oriented wires 33. Both upper and lower ends of each wire 33 are provided with double knots 34.

The lower part 36 has horizontally oriented wires 37. Both the left and rights ends of each wire 37 are provided with double knots 38.

A wire rod 39 connects the double knots 34 at the lower side of the upper part with the most upper wire of lower part 36.

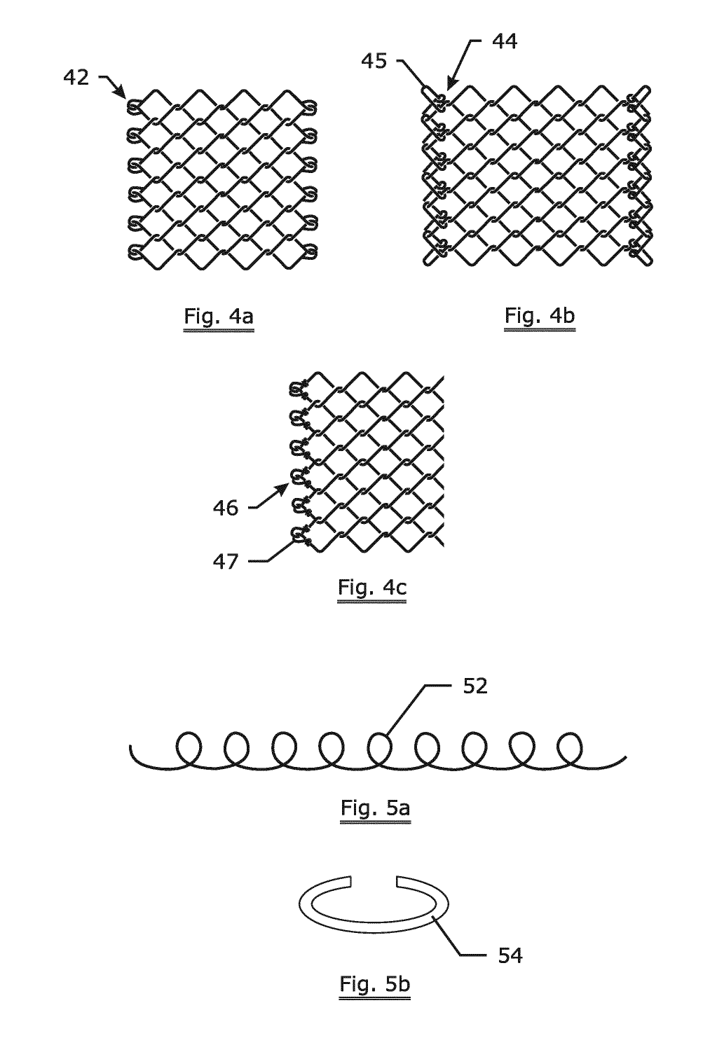

FIG. 4a, FIG. 4b and FIG. 4c illustrate various knots which may be used at the wire ends.

FIG. 4a illustrates an example of a simple knot 42. The wire end which was cut is knotted by bending the tip of the open wire end over the wire end of a next wire and by closing thus forming a simple knot.

FIG. 4b illustrates a double knot 44. Each wire end is first forming a loop 45 before being knotted to an adjacent wire. In addition, the loops of adjacent wires are entangled. A double knot 44 provides more strength than a simple knot 42.

FIG. 4c illustrates a spring knot 46. Each wire end forms a loop 47 and is knotted with itself. The loops 47 of adjacent wires are entangled.

FIG. 5a and FIG. 5b illustrate means for joining various mesh parts to each other.

FIG. 5a illustrates an example of a spiral rope or rod 52 that may be used to join the sides of two mesh parts. This rope is interwoven between the squares at the sides of adjacent mesh parts.

FIG. 5b illustrates an example of a clip 54 which is used to connect two adjacent mesh parts.

1-14. (canceled)

15. An aquaculture net having one or more side walls, said side walls comprising wires in a wavy form with maxima and minima, wherein the maxima of one wire interlock with minima of a neighboring wire to form patterns of a series of diamonds, characterized in that said at least one of said side walls comprises at least two parts wherein the wire direction in one of said parts is different from the wire direction in another of said parts.

16. An aquaculture net according to claim 15,
wherein the wire direction in one of said parts forms a first angle with the wire direction in another of said parts, said angle being larger than 45°.

17. An aquaculture net according to claim 15, wherein said at least two parts form an upper part and a lower part of said side wall.

18. An aquaculture net according to claim 17, wherein the wire direction in said upper part forms a second angle with a vertical, said second angle being smaller than 15°.

19. An aquaculture net according to claim 17, wherein the wire direction of said lower part forms a third angle with a horizontal, said third angle being smaller than 15°.

20. An aquaculture net according to claim 15, wherein said aquaculture net is a chain-link fence.

21. An aquaculture net according to claim 15, wherein said wires are metal wires.

22. An aquaculture net according to claim 21, wherein said metal wires are metal plated steel wires.

23. An aquaculture net according to claim 22, wherein said steel wires have a wire diameter that is smaller than 4.0 mm.

24. An aquaculture net according to claim 15, said aquaculture net having dimensions which are greater than 1 m×1 m×1 m (length×width×depth).

25. An aquaculture net according to claim 15, said at least two parts are joined to each other.

26. An aquaculture net according to claim 25, wherein said two parts are joined to each other by means of a spiral, wire rod, tube or connection clip.

27. An aquaculture net according to claim 26, wherein said wires have ends which are knotted.

28. An aquaculture net according to claim 27, wherein said spiral, said wire rod, said tube or said connection clip connects the knotted ends of one part to a neighbouring wire of another part.
